(19) United States
(12) Patent Application Publication
(10) Pub. No.: US 2004/0050233 A1
(43) Pub. Date: Mar. 18, 2004

(54) Circular-saw blade comprising expansion slits extending radially inwards

(76) Inventors: Herbert Humenberger, Schardenberg (AT); Richard Patsch, Riedau (AT); Zeljko Pekec, Riedau (AT)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/450,198

(22) PCT Filed: May 15, 2002
(86) PCT No.: PCT/DE02/01726

(30) Foreign Application Priority Data
May 18, 2001 (DE) 101 24 687.0

(51) Int. Cl. B27B 13/02

(52) U.S. Cl. 83/835

(57) ABSTRACT

A circular saw blade, consisting of a supporting body (1) and a plurality of cutting tips (2) which are inserted into the supporting body (1) such as to be distributed over the circumference and have a front rake face (2a) and a rear bearing face (2b) and also a cutting edge forming a pitch circle diameter (F), having a chip space (3) formed in front of each cutting tip (2) and a plurality of expansion slots (4) which are arranged such as to be distributed over the circumference, extend radially inward, have an essentially triangular terminal configuration (5) with a center (Z) lying inside the curve path and originate at the root of the chip space (3), is distinguished by the following features:

a) the pitch circle diameter (F) is at most 2 mm larger than the diameter (T) of the supporting body (1);

b) the distance (L) of the expansion slots (4) from their origin up to the center (Z) is at most 17 mm;

c) the smallest chip space diameter (S) of each chip space (3) is at most 13 mm smaller than the pitch circle diameter (F);

d) the rake face (2a) of the cutting tips (2) runs inclined relative to the bearing face (2b).

The invention relates to a circular saw blade, consisting of a supporting body and a plurality of cutting tips which are inserted into the supporting body such as to be distributed over the circumference and have a front rake face and a rear bearing face and also a cutting edge forming a pitch circle diameter, having a chip space formed in front of each cutting tip and a plurality of expansion slots which are arranged such as to be distributed over the circumference, extend radially inward, have an essentially triangular terminal configuration with a center lying inside the curve path and originate at the root of the chip space.

Such a circular saw blade has been disclosed, for example, by DE 92 16 744 U.

The expansion slots serve to absorb thermal expansions and to interrupt vibrations occurring in the supporting body. The task of the triangular terminal configuration is to convert the vibration energy into heat by friction.

Circular saw machines are known in which the saw blades are firmly clamped in place on the shaft between flanges, and there are those in which the saw blades are slipped loosely onto a splined or polygonal shaft and are guided on the supporting body between fixed and yielding guides (blade-body guides).

In particular in more recent circular saw machines, however, the saw blades are both clamped in place between flanges and additionally guided on the supporting body.

The object of the invention is to develop the circular saw blade described at the beginning in such a way that it has a stable vibration behavior when it is used in circular saw machines in which it is both clamped in place between flanges and guided in the outer region of the supporting body.

To achieve this object, the saw blade of the generic type is distinguished by the following features:

a) the pitch circle diameter is at most 2 mm larger than the diameter of the supporting body;

b) the distance of the expansion slots from their origin up to the center is at most 17 mm;

c) the smallest chip space diameter of each chip space is at most 13 mm smaller than the pitch circle diameter;

d) the rake face of the cutting tips runs inclined relative to the bearing face.

This design produces a geometric form which delivers the requisite internal stresses in the supporting body for repeated clamping of the tool. In addition, the natural frequency of the saw blade achieved by these measures leads to a smoother running behavior.

Due to the small chip space diameter, the tooth rim is closed to a great extent, and, due to the small difference between pitch circle diameter and supporting body diameter, a circular chip thickness limiter is created in such a way that a maximum chip thickness of less than 1 mm results. This chip thickness limitation provides for maximum stability of the saw in operation, in particular in the case of knotty and cracked wood.

Due to the conical arrangement of rake face and bearing face, a positive variation of the geometry of the secondary cutting edge is achieved. In addition to the smoother operating behavior of, in particular, high-speed circular saw blades, the cutting quality is additionally increased.

The angle of inclination between rake face and bearing face of the cutting tips preferably lies within the range of 1° to 7°.

The width of the expansion slots is preferably 0.3 mm. The expansion slots may be filled with a permanently elastic material in order to avoid impairment of the guidance properties in the outer region of the supporting body.

It has surprisingly been found that a further improved behavior of the circular saw blade is achieved if an uneven number of cutting tips are inserted and/or the expansion slots are distributed irregularly over the circumference.

To prevent resin deposit during operation, the supporting body may be provided with a surface coating. This ensures the cleanliness of the guide plane and increased cutting quality and tool life.

In addition, it has been found to be very advantageous if the expansion slots are designed to be wider in their straight region than in the triangular region.

An exemplary embodiment of the invention is to be described in more detail below with the aid of a drawing, in which:

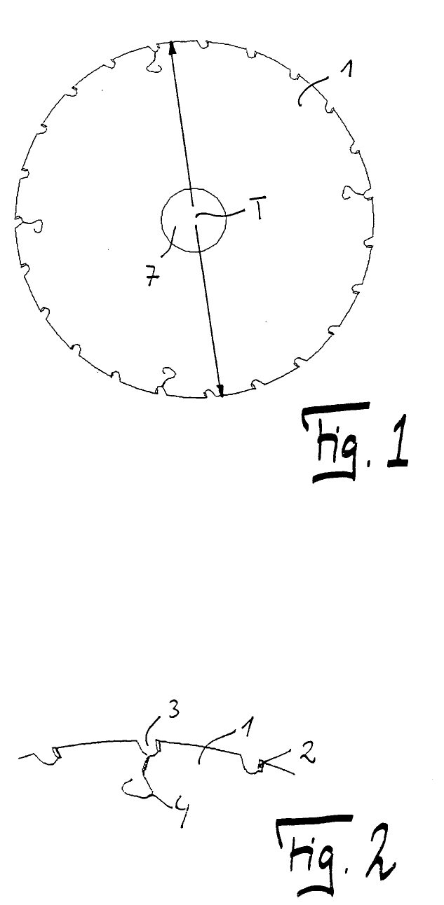

FIG. 1 shows the view of a circular saw blade;

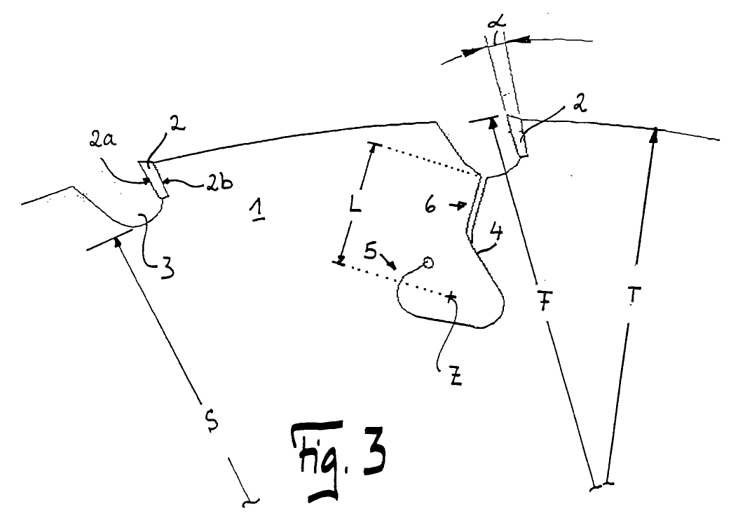

FIG. 2 shows an enlarged detail from FIG. 1;

FIG. 3 shows an enlarged detail from FIG. 2;

The circular saw blade consists of the supporting body 1 and the cutting tips 2, which are brazed or adhesively bonded in place in the supporting body 1 and form the saw teeth. A chip space 3 is incorporated in front of each cutting tip 2. A hole 7 for slipping onto the shaft (not shown in any more detail here) of a circular saw machine is provided in the center of the supporting body 1. Originating in some chip spaces 3 at the deepest point (smallest chip space diameter) is an expansion slot 4, which first of all is directed radially inward in a straight region 6 and merges at the end into a triangular terminal configuration 5. The geometric center of the triangular region 5 forms the center Z. The distance L of the expansion slot 4 from its origin up to the center is at most 17 mm. As FIG. 3 shows, the pitch circle diameter F of the cutting edge formed on the cutting tip 2 is at most 2 mm larger than the diameter T of the supporting body 1. This results in a maximum chip thickness of at most 1 mm (F/2−T/2) on the workpiece. Due to the small projection, the chip thickness limiter is designed to be circular.

The smallest chip space diameter S of each chip space 3 is designed to be at most 13 mm smaller than the pitch circle diameter F.

The rake face 2a of the cutting tip 2 is inclined by an angle of 1° to 7° relative to the bearing face 2b, with which the cutting tip 2 bears in the supporting body 1. To reduce resin deposits on the supporting body 1, the circular saw blade is provided with a surface coating.

The expansion slot 4 is designed to be wider in the straight region 6 than in the triangular region 5. The expansion slot 4 may be filled with a permanently elastic compound, which can provide for improved guidance. The guide device formed in the saw machine is normally operated with compressed air. An air cushion is therefore built up for guiding the supporting body 1. Closed expansion slots reduce the air requirement for the guidance.

### LIST OF DESIGNATIONS

1 Supporting body

2 Cutting tip

2a Rake face

2b Bearing face

3 Chip space

4 Expansion slot

5 Triangular region

6 Straight region

7 Hole

Angle

F Pitch circle diameter

L Distance/orifice to center

S Chip space diameter

T Diameter of supporting body

Z Center

1. A circular saw blade, consisting of a supporting body (1) and a plurality of cutting tips (2) which are inserted into the supporting body (1) such as to be distributed over the circumference and have a front rake face (2a) and a rear bearing face (2b) and also a cutting edge forming a pitch circle diameter (F), having a chip space (3) formed in front of each cutting tip (2) and a plurality of expansion slots (4) which are arranged such as to be distributed over the circumference, extend radially inward, have an essentially triangular terminal configuration (5) with a center (Z) lying inside the curve path and originate at the root of the chip space (3), characterized by the following features:
a) the pitch circle diameter (F) is at most 2 mm larger than the diameter (T) of the supporting body (1);
b) the distance (L) of the expansion slots (4) from their origin up to the center (Z) is at most 17 mm;
c) the smallest chip space diameter (S) of each chip space (3) is at most 13 mm smaller than the pitch circle diameter (F);
d) the rake face (2a) of the cutting tips (2) runs inclined relative to the bearing face (2b).

2. The circular saw blade as claimed in claim 1, characterized in that the angle of inclination ( ) between rake face (2a) and bearing face (2b) lies within the range of 1° to 7°.

3. The circular saw blade as claimed in claim 1, characterized in that the width of the expansion slots (4) is at most 0.3 mm.

4. The circular saw blade as claimed in claim 1, characterized in that the expansion slots (4) are distributed irregularly over the circumference.

5. The circular saw blade as claimed in one or more of the preceding claims, characterized by a surface coating of the supporting body (1) for avoiding resin deposit during operation.

6. The circular saw blade as claimed in claim 3, characterized in that the expansion slots (4) are designed to be wider in their straight region (5) than in the triangular region (6).

7. The circular saw blade as claimed in claim 1, characterized in that the expansion slots (4) are filled with a permanently elastic material.
